(19) United States
(12) Patent Application Publication
(10) Pub. No.: US 2026/0097586 A1
(43) Pub. Date: Apr. 9, 2026

(54) CONTAINER CONTAINING A LIQUID DISCHARGE HEAD

(71) Applicant: CANON KABUSHIKI KAISHA, Tokyo (JP)

(72) Inventor: KAZUNORI YABE, Tokyo (JP)

(21) Appl. No.: 19/348,674

(22) Filed: Oct. 2, 2025

(30) Foreign Application Priority Data
Oct. 9, 2024 (JP) 2024-177319

(51) Int. Cl. B41J 2/175

(52) U.S. Cl. CPC B41J 2/17513; B41J 2/17553

(57) ABSTRACT

A container contains a liquid discharge head integrally including a liquid tank for containing liquid and includes a holding structure configured to hold the liquid discharge head contained in the container. The holding structure includes a first engaging portion provided on the liquid discharge head, and a second engaging portion provided on the container in a position opposite to the first engaging portion when the liquid discharge head is contained in the container and engageable with the first engaging portion.

### BACKGROUND

### Field of the Technology

The present disclosure relates to a container containing a liquid discharge head comprising a holding structure.

### Description of the Related Art

From the perspective of environmental protection, a liquid discharge head integrally provided with a liquid tank may be removed from a liquid discharge apparatus after use, collected, and refilled with liquid for reuse. For this purpose, it is conceivable to contain a used liquid discharge head in a packaging container that is used at the time of shipment so as to collect the used liquid discharge head. However, in the case of Blister containers, which are often used as packaging containers for liquid discharge heads, the Blister containers cannot be resealed once opened. Therefore, even if a used liquid discharge head is contained in an opened Blister container and collected, the liquid discharge head may pop out of the Blister container due to vibration during transportation, and a discharge port surface for discharging liquid may be damaged. Japanese Patent Laid-Open No. 2012-051240 describes a technology for preventing a liquid discharge head from popping out of a container during distribution by sticking an adhesive tape straddling over an opening surface of the container.

However, if the technology described in Japanese Patent Laid-Open No. 2012-051240 is used in collecting a liquid discharge head using an opened Blister container, it is necessary to pack an adhesive tape with the Blister container and the number of parts increases.

### SUMMARY

The present disclosure is directed to a container containing a liquid discharge head comprising a holding structure.

According to an aspect of the present disclosure, a container containing a liquid discharge head, the liquid discharge head integrally including a liquid tank for containing liquid, comprises a holding structure configured to hold the liquid discharge head contained in the container, the holding structure comprising: a first engaging portion provided on the liquid discharge head; and a second engaging portion provided on the container in a position opposite to the first engaging portion when the liquid discharge head is contained in the container and engageable with the first engaging portion.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view showing a holding structure for a liquid discharge head according to a first embodiment.

FIG. 1B is a top view of a container containing the liquid discharge head.

FIG. 1C is a side cross-sectional view of the container taken along a line IC-IC in FIG. 1A.

FIG. 1D is an enlarged view of a portion encircled by a circle ID in FIG. 1C.

FIG. 1E is a cross-sectional view of a package.

FIG. 2A is a perspective view showing a holding structure for the liquid discharge head according to a second embodiment.

FIG. 2B is a top view of the container containing the liquid discharge head.

FIG. 2C is a side cross-sectional view of the container taken along a line IIC-IIC in FIG. 2A.

FIG. 2D is an enlarged view of a portion encircled by a circle IID in FIG. 2C.

FIG. 3A is a top view showing a holding structure of the liquid discharge head according to a third embodiment.

FIG. 3B is a side cross-sectional view of the container taken along a line IIIB-IIIB in FIG. 3A.

FIG. 3C is an enlarged view of a portion encircled by a circle IIIC in FIG. 3B.

FIG. 4A is a top view showing a holding structure for the liquid discharge head according to a fourth embodiment.

FIG. 4B is a side cross-sectional view of the container taken along a line IVB-IVB in FIG. 4A.

FIG. 4C is an enlarged view of a portion encircled by a circle IVC in FIG. 4B.

FIG. 5A is a top view showing a holding structure for the liquid discharge head according to a fifth embodiment.

FIG. 5B is a side cross-sectional view of the container taken along a line VB-VB in FIG. 5A.

FIG. 5C is an enlarged view of a portion encircled by a circle VC in FIG. 5B.

### DESCRIPTION OF THE EMBODIMENTS

The embodiments of the present disclosure will be described below with reference to the drawings. As a holding structure for a liquid discharge head according to the present disclosure, an example of a case where a used liquid discharge head is contained and held by a packaging container (specifically, a Blister container) at the time of shipment will be described herein, but the present disclosure is not limited thereto. It should be noted that the dimensions, materials, shapes, and relative arrangements of the components shown below may be appropriately changed depending on the configuration and various conditions of the liquid discharge head and container to which the present disclosure is applied and are not intended to limit the scope of the present disclosure.

### (First Embodiment)

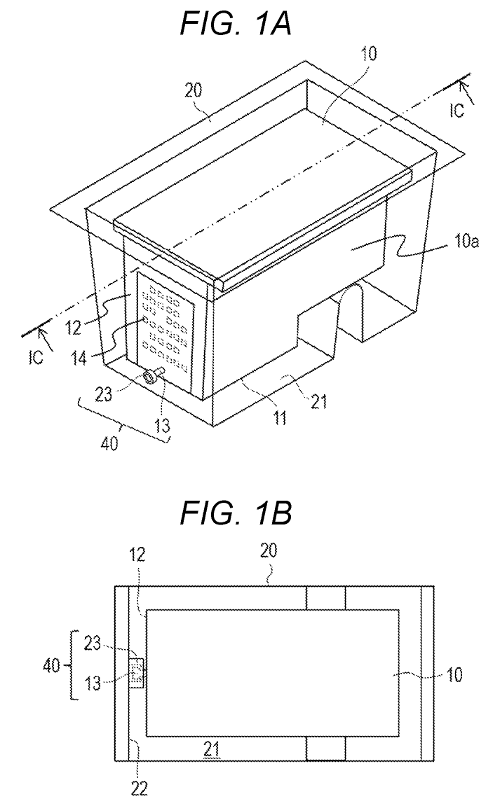

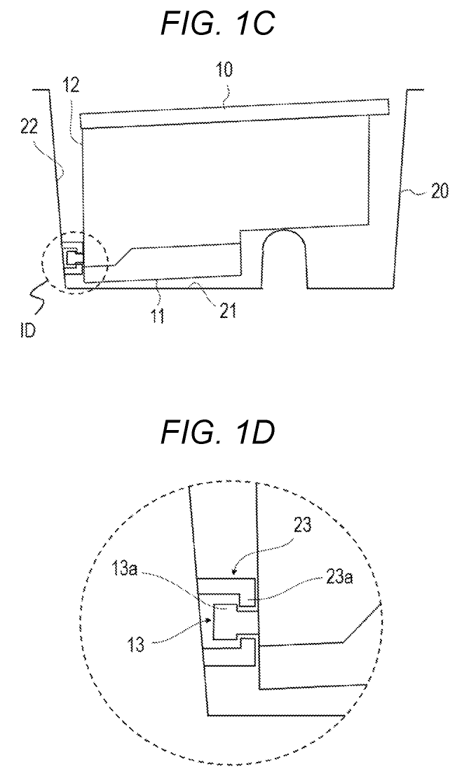

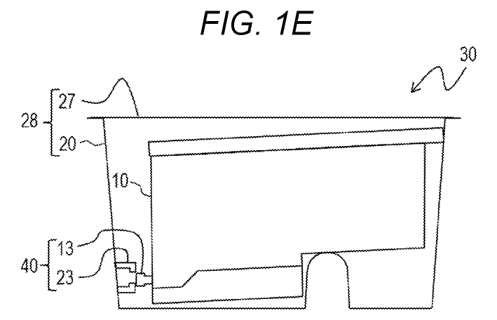

FIG. 1A is a perspective view showing a holding structure 40 for a liquid discharge head 10 according to a first embodiment. FIG. 1B is a top view of a container (container body) 20 containing the liquid discharge head 10. FIG. 1C is a side cross-sectional view of the container 20 taken along a line IC-IC in FIG. 1A. FIG. 1D is an enlarged view of a portion encircled by a circle ID in FIG. 1C. FIG. 1E is a cross-sectional view of a package 30.

The liquid discharge head 10 is detachably mounted on a liquid discharge apparatus, discharges a liquid such as ink and records an image on a recording medium, and is integrally provided with a liquid tank 10a configured to contain the liquid to be discharged. A brand-new liquid discharge head 10 is provided in the form of a package 30 in which the brand-new liquid discharge head 10 is contained in a packaging container 28 in a sealed state, is removed from the packaging container 28 when used, and is mounted on a liquid discharge apparatus. A used liquid discharge head 10, of which the liquid tank 10a is empty, is removed from the liquid discharge apparatus, and is contained in the packaging container 28 after opening, that is, a container 20 from which the lid 27 is peeled off to open at an upper surface of the container 20. At this time, the liquid discharge head 10 is contained in the container 20 so that a discharge port surface 11 in which a discharge port for discharging the liquid is formed is opposed to a bottom surface 21 of the container 20 as with during distribution and is collected while being held in the container 20 by a holding structure 40 described later. The container 20 may be made of resin or paper.

As the holding structure 40 configured to hold (fix) the liquid discharge head 10 in the container 20, a protruding portion (first engaging portion) 13 protruding from an outer surface (hereinafter referred to as "front surface") 12 adjacent to the discharge port surface 11 is provided on the liquid discharge head 10. On the other hand, a cylindrical portion (second engaging portion) 23 protruding from an inner surface (hereinafter referred to as "front inner surface") 22 opposite to the front surface 12 of the liquid discharge head 10 is provided on the container 20. The cylindrical portion 23 is provided at a position opposite to the protruding portion 13 when the liquid discharge head 10 is contained in the container 20 and is configured to be engageable with the protruding portion 13. Specifically, at least one of the protruding portion 13 and the cylindrical portion 23 is elastically deformed so that the protruding portion 13 is fitted inside the cylindrical portion 23.

With such mutual engagement of the protruding portion 13 and the cylindrical portion 23, the liquid discharge head 10 can be contained and held (fixed) in the container 20 without additional treatment such as sticking an adhesive tape. Therefore, even when it is necessary to transport the liquid discharge head 10 contained in the container 20 and collected, the liquid discharge head 10 is not likely to fly out of the container 20 due to vibration during transportation. As a result, for example, even when many containers 20 are packed together in one bag to collect the used liquid discharge heads 10, it is possible to prevent the liquid discharge head 10 from coming into contact with other liquid discharge heads 10 and the containers 20 and damaging the discharge port surface 11. In the form of the package 30, that is, in the form of the brand-new liquid discharge head 10 contained in the packaging container 28 of which the lid 27 in the film shape is welded and sealed to the upper surface of the container 20, the protruding portion 13 and the cylindrical portion 23 need not be fitted to each other (FIG. 1E).

The shapes of the protruding portion 13 and the cylindrical portion 23 are not particularly limited as long as they can be fitted to each other. For example, the protruding portion 13 may have a column shape with a constant outer diameter, and accordingly, the cylindrical portion 23 may be cylindrical with a constant inner diameter and larger than the outer diameter of the protruding portion 13. However, the protruding portion 13 and the cylindrical portion 23 may have shapes shown in FIG. 1D, respectively, in order to enhance the effect of preventing the protruding portion 13 from coming off the cylindrical portion 23. That is, a large-diameter portion 13a having an outer diameter larger than an outer diameter of other portion is formed on a tip side of the protruding portion 13, and a small-diameter portion 23a having an inner diameter smaller than an inner diameter of other portion and smaller than the outer diameter of the large-diameter portion 13a of the protruding portion 13 is formed on a tip side of the cylindrical portion 23. With such a shape, the protruding portion 13 can be prevented from coming off the cylindrical portion 23 when the protruding portion 13 is fitted into the cylindrical portion 23, and the liquid discharge head 10 can be securely fixed to the container 20 with a minimum necessary configuration. In order to obtain the same come-off prevention effect, the protruding portion 13 and the cylindrical portion 23 may be engaged with each other by a so-called snap-fit shape.

Although the arrangement of the protruding portion 13 and the cylindrical portion 23 is not particularly limited, the protruding portion 13 may be provided close to the discharge port surface 11 of the liquid discharge head 10. Therefore, the cylindrical portion 23 may be provided close to the bottom surface 21 of the container 20. Thus, even when the liquid discharge head 10 vibrates in the container 20 during transportation, since the protruding portion 13 serves as a fulcrum of vibration, the vibration is suppressed at the discharge port surface 11 close to the protruding portion 13, and the risk that the discharge port surface 11 contacts the bottom surface 21 of the container 20 so as to be damaged can be reduced.

### (Second Embodiment)

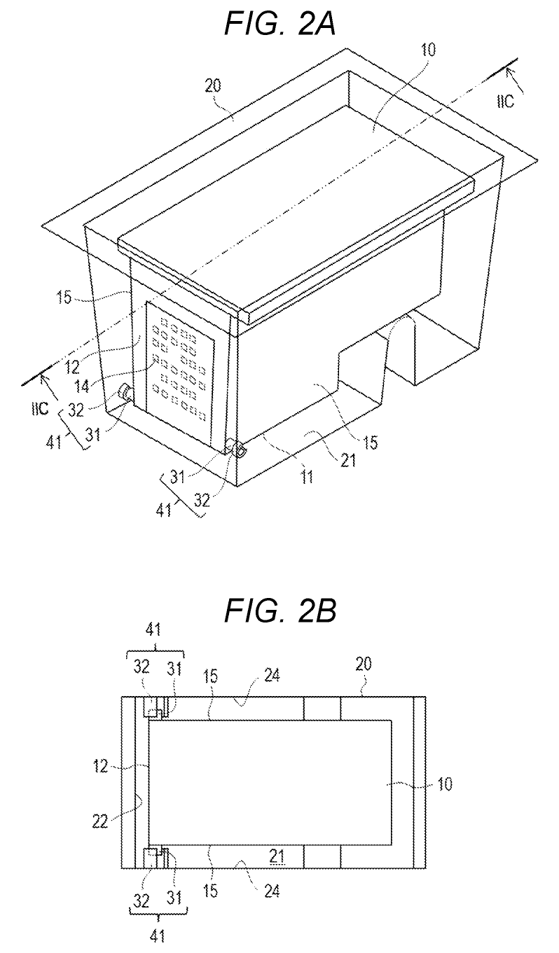

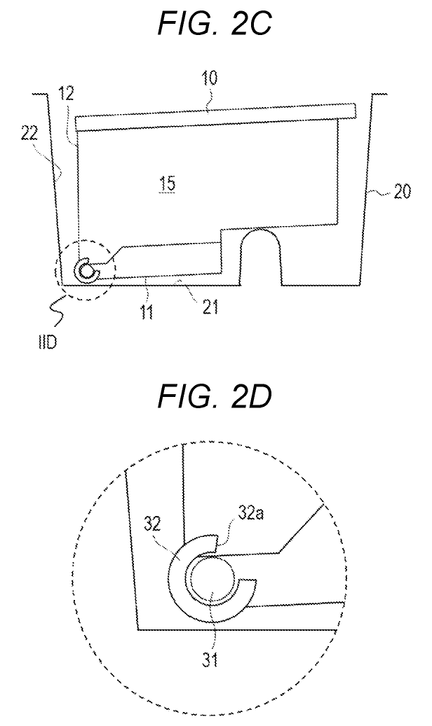

FIG. 2A is a perspective view showing a holding structure 41 of the liquid discharge head 10 according to a second embodiment. FIG. 2B is a top view of the container 20 containing the liquid discharge head 10. FIG. 2C is a side cross-sectional view of the container 20 taken along a line IIC-IIC in FIG. 2A. FIG. 2D is an enlarged view of a portion encircled by a circle IID in FIG. 2C. Hereinafter, differences from the first embodiment will be mainly described.

The holding structure 41 of the second embodiment includes a protruding portion 31 (first engagement) and a cylindrical portion 32 (second engagement). In the second embodiment, a plurality of protruding portions 31 and a plurality of cylindrical portions 32 are respectively provided. Specifically, the protruding portions 31 are respectively provided on a pair of outer surfaces 15 adjacent to the discharge port surface 11 of the liquid discharge head 10, and the cylindrical portions 32 are respectively provided on a pair of inner surfaces 24 of the container 20 opposite to the outer surfaces 15. As a result, since the liquid discharge head 10 and the container 20 have a plurality of fixed positions (two in the second embodiment), the external force (vibration, etc.) acting on the liquid discharge head 10 during transportation can be dispersed, and the durability of the protruding portions 31 and the cylindrical portions 32 can be improved. In addition, the protruding portions 31 and the cylindrical portions 32 can be made into simple shapes, respectively. Specifically, the protruding portions 31 can have a column shape with a constant outer diameter, and accordingly, the cylindrical portions can be cylindrical with an inner diameter constant and larger than the outer diameter of the protruding portions 31.

In addition, the cylindrical portion 32 is formed with a cutout 32a that is cut along the axial direction with a width smaller than the outer diameter of the corresponding protruding portion 31 and opens toward the upper surface of the container 20. As a result, the workability of fixing the liquid discharge head 10 to the container 20, that is, the workability (ease of fitting) of fitting the protruding portion 31 into the cylindrical portion 32 can be improved, and the necessary and sufficient come-off prevention function can be ensured. However, if the material of the container 20 makes it easy to deform the cylindrical portion 32, the cutout 32a may not be formed. On the other hand, in the second embodiment, the engagement between the protruding portion 31 and the cylindrical portion 32 may be realized by a so-called snap-fit shape.

In the case where there are a plurality of fitting positions of the protruding portions 31 and the cylindrical portions 32 as in the second embodiment, in order to improve the workability of removing the liquid discharge head 10 from the container 20, the ease of disengagement of the protruding portion 31 from the cylindrical portion 32 may be different for each position. For this purpose, in a case where the outer diameters of the two protruding portions 31 are equal, the inner diameters of the two cylindrical portions 32 may be different from each other. For example, the inner diameter of one cylindrical portion 32 may be made equal to the outer diameter of the protruding portion 31, while the inner diameter of the other cylindrical portion 32 may be made larger than the outer diameter of the protruding portion 31. As a result, since the fitting strength of the other cylindrical portion 32 with the protruding portion 31 is relatively weak, the protruding portion 31 easily comes off from the other cylindrical portion 32. Alternatively, in a case where the inner diameters of the two cylindrical portions 32 are equal, the outer diameters of the two protruding portions 31 may be different from each other. For example, the outer diameter of one protruding portion 31 may be made equal to the inner diameter of the cylindrical portion 32, while the outer diameter of the other protruding portion 31 may be made smaller than the inner diameter of the cylindrical portion 32. As a result, since the fitting strength of the other protruding portion 31 with the cylindrical portion 32 is relatively weak, the other protruding portion 31 easily comes off from the cylindrical portion 32. Thus, compared with the case where the fitting strength of the protruding portions 31 with the cylindrical portions 32 are all the same, the impact when the liquid discharge head 10 is removed from the container 20 can be suppressed, and the risk that the liquid discharge head 10 unexpectedly contacts the container 20 so as to be damaged can be reduced.

The arrangement of the protruding portions 31 and the cylindrical portions 32 is not particularly limited, but from the same viewpoint as in the first embodiment, the protruding portion 31 may be provided close to the front surface 12 (an outer surface other than the outer surfaces 15 provided with the protruding portions 31) of the liquid discharge head 10. As a result, since the protruding portions 31 serve as fulcrums of vibration during transportation, the vibration is suppressed at the front surface 12 of the liquid discharge head 10 close to the protruding portions 31, and the possibility that a connection terminal 14 provided in the front surface 12 contacts the front inner surface 22 of the container 20 and is damaged can be reduced.

The number of the protruding portions 31 is not limited to two (a pair) but may be three or more, and accordingly, the number of the cylindrical portions 32 is not limited to two (a pair) but may be three or more.

### (Third Embodiment)

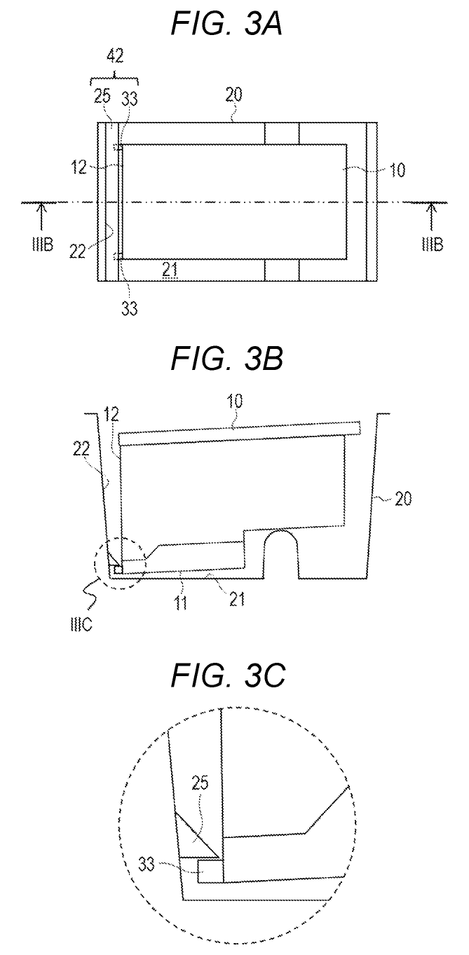

FIG. 3A is a top view showing a holding structure 42 of the liquid discharge head 10 according to a third embodiment. FIG. 3B is a side cross-sectional view of the container taken along a line IIIB-IIIB in FIG. 3A. FIG. 3C is an enlarged view of a portion encircled by a circle IIIC in FIG. 3B. Hereinafter, differences from the first embodiment will be mainly described.

The holding structure 42 of the third embodiment includes a protruding portion 33 (first engaging portion) and a block portion 25 (second engaging portion). In the third embodiment, two protruding portions 33 are provided on the front surface 12 of the liquid discharge head 10, while the container 20 is provided with a block portion 25 instead of the cylindrical portion 23 of the first embodiment. The block portion 25 is provided so as to extend along a lateral direction on the front inner surface 22 of the container 20 and is configured so that when the liquid discharge head 10 is contained in the container 20, the protruding portions 33 abut and engage a lower surface of the block portion 25. With this configuration, the liquid discharge head 10 can be contained and held (fixed) in the container 20 as in the first embodiment. In the example shown in FIG. 3A, only one block portion 25 is provided, but it may be divided into two in the lateral direction of the front inner surface 22 according to the number of protruding portions 33. In addition, the number of protruding portions 33 is not limited to two as shown in FIG. 3A, but three or more may be provided with a space (spaces) in between in the lateral direction on the front surface 12 of the liquid discharge head 10, and three or more block portions 25 may be provided accordingly.

### (Fourth Embodiment)

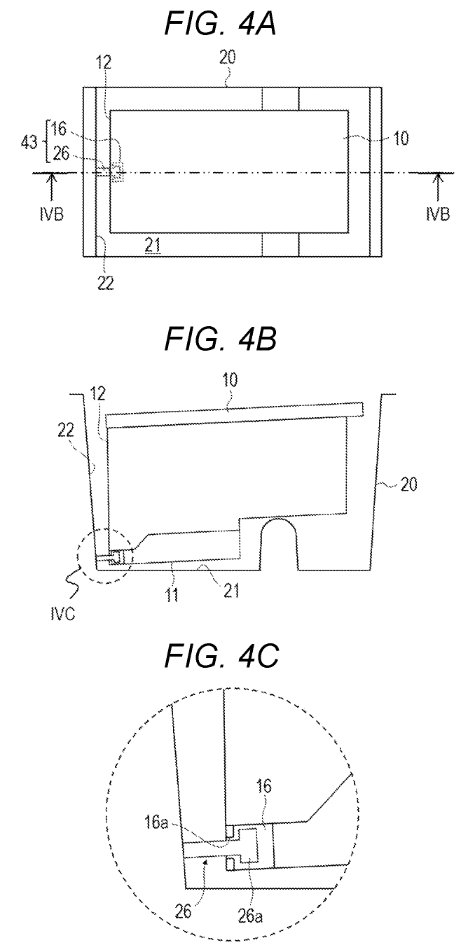

FIG. 4A is a top view showing a holding structure 43 of the liquid discharge head 10 according to a fourth embodiment. FIG. 4B is a side cross-sectional view of the container 20 taken along a line IVB-IVB in FIG. 4A. FIG. 4C is an enlarged view of a portion encircled by a circle IVC in FIG. 4B. Hereinafter, differences from the first embodiment will be mainly described.

The holding structure 43 of the fourth embodiment includes a hole portion (first engaging portion) 16 and a protruding portion (second engaging portion) 26. In the fourth embodiment, contrary to the first embodiment, the hole portion 16, having a circular shape, corresponding to the cylindrical portion 23 of the first embodiment is provided in the liquid discharge head 10, and the protruding portion 26 is provided on the container 20. The hole portion 16 is provided at the position where the protruding portion 13 is provided in the first embodiment, that is, in the front surface 12 of the liquid discharge head 10. The protruding portion 26 is provided at the position where the cylindrical portion 23 is provided in the first embodiment, that is, on the front inner surface 22 of the container 20. Then, the protruding portion 26 is elastically deformed so as to be fitted into the hole portion 16, so that the liquid discharge head 10 can be fixed to the container 20 as in the first embodiment.

In the fourth embodiment, the same configuration as in the first embodiment may be provided in order to enhance the effect of preventing the protruding portion 26 from coming off the hole portion 16. That is, a small-diameter portion 16a having an inner diameter smaller than an inner diameter of other portion is formed on an opening side of the hole portion 16, and a large-diameter portion 26a having an outer diameter larger than an outer diameter of other portion and larger than the inner diameter of the small-diameter portion 16a of the hole portion 16 is formed on a tip side of the protruding portion 26. Also, it is similar to the first embodiment that the hole portion 16 and the protruding portion 26 may be engageable with each other in a so-called snap-fit shape, and the arrangement of the hole portion 16 and the protruding portion 26 may be similar to the arrangement of the protruding portion 13 and the cylindrical portion 23 in the first embodiment. That is, the hole portion 16 may be provided close to the discharge port surface 11 of the liquid discharge head 10, and the protruding portion 26 is provided close to the bottom surface 21 of the container 20.

### (Fifth Embodiment)

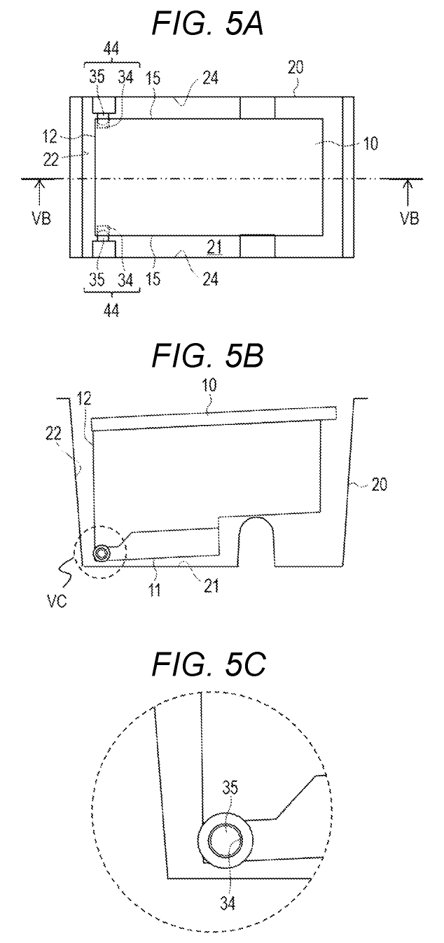

FIG. 5A is a top view showing a holding structure 44 for the liquid discharge head 10 according to a fifth embodiment. FIG. 5B is a side cross-sectional view of the container 20 taken along a line VB-VB in FIG. 5A. FIG. 5C is an enlarged view of a portion encircled by a circle VC in FIG. 5B. Hereinafter, differences from the second embodiment will be mainly described.

The holding structure 44 of the fifth embodiment includes hole portions (first engaging portions) 34 and protruding portions (second engaging portions) 35. In the fifth embodiment, contrary to the second embodiment, the liquid discharge head 10 is provided with the hole portions 34 corresponding to the cylindrical portions 32 of the second embodiment, and the container 20 is provided with the protruding portions 35. The hole portions 34 are provided on the positions where the protruding portions 31 are provided in the second embodiment, that is, on the pair of outer surfaces 15 of the liquid discharge head 10. The protruding portions 35 are respectively provided at the positions where the cylindrical portions 32 are provided in the second embodiment, that is, on the pair of inner surfaces 24 of the container 20. Then, the protruding portions 35 are elastically deformed and fitted into the hole portions 34, so that the liquid discharge head 10 can be fixed to the container 20 at the plurality of positions as in the second embodiment. In the fifth embodiment, the hole portions 34 are simple circular hole portions, but a length of the protruding portions 35 may be such that parts of the protruding portions 35 enter the hole portions 34.

In the fifth embodiment, as in the second embodiment, the ease of disengagement of the protruding portions 35 from the hole portions 34 may be different for each fitting position between the hole portions 34 and the protruding portions 35. That is, in a case where inner diameters of the two hole portions 34 are equal, for example, an outer diameter of one protruding portion 35 may be made equal to the inner diameters of the hole portions 34, while an outer diameter of the other protruding portion 35 may be made smaller than the inner diameters of the hole portions 34. Alternatively, in a case where outer diameters of the two protruding portions 35 are equal, for example, an inner diameter of one hole portion 34 may be made equal to the outer diameters of the protruding portions 35, while an inner diameter of the other hole portion 34 may be made larger than the outer diameters of the protruding portions 35. Also, as in the second embodiment, the hole portions 34 and the protruding portions 35 may be engageable with each other in a so-called snap-fit shape, and the arrangement of the hole portions 34 and the protruding portions 35 may be similar to the arrangement of the protruding portions 31 and the cylindrical portions 32 in the second embodiment. That is, the hole portions 34 may be provided close to the front surface 12 of the liquid discharge head 10.

According to the embodiments described above, the container 20 containing the liquid discharge head 10 comprising the holding structures 40, 41, 42, 43 and 44 can be obtained.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177319, filed October 9, 2024, which is hereby incorporated by reference herein in its entirety.

WHAT IS CLAIMED IS:

1. A container containing a liquid discharge head, the liquid discharge head integrally including a liquid tank for containing liquid, comprising a holding structure configured to hold the liquid discharge head contained in the container, the holding structure comprising:
a first engaging portion provided on the liquid discharge head; and
a second engaging portion provided on the container in a position opposite to the first engaging portion when the liquid discharge head is contained in the container and engageable with the first engaging portion.

2. The container containing the liquid discharge head according to claim 1, wherein the liquid discharge head is contained in the container so that a discharge port surface in which a discharge port for discharging the liquid is formed is opposite to a bottom surface of the container, and
wherein the first engaging portion is provided adjacent to the discharge port surface of the liquid discharge head.

3. The container containing the liquid discharge head according to claim 2, wherein the first engaging portion comprises a protruding portion protruding from an outer surface adjacent to the discharge port surface of the liquid discharge head.

4. The container containing the liquid discharge head according to claim 3, wherein the second engaging portion comprises a block portion extending from an inner surface of the container opposite to the outer surface of the liquid discharge head, and
wherein the liquid discharge head is held in the container by the protruding portion abutting and engaging a lower surface of the block portion.

5. The container containing the liquid discharge head according to claim 2, wherein the second engaging portion comprises a cylindrical portion protruding from an inner surface of the container opposite to the outer surface of the liquid discharge head, and wherein the liquid discharge head is held in the container by the protruding portion fitting inside of the cylindrical portion.

6. The container containing the liquid discharge head according to claim 5, wherein the protruding portion comprises a plurality of protruding portions, and the cylindrical portion comprises a plurality of cylindrical portions.

7. The container containing the liquid discharge head according to claim 6, wherein the plurality of protruding portions comprise a pair of protruding portions provided on a pair of outer surfaces adjacent to the discharge port surface of the liquid discharge head, and
wherein the plurality of cylindrical portions include a pair of cylindrical portions provided on a pair of inner surfaces of the container opposite to the pair of outer surfaces of the liquid discharge head, respectively.

8. The container containing the liquid discharge head according to claim 7, wherein the pair of protruding portions are provided close to an outer surface of the liquid discharge head, adjacent to the discharge port surface of the liquid discharge head, different from the pair of outer surfaces.

9. The container containing the liquid discharge head according to claim 7, wherein each of the pair of cylindrical portions is provided with a cutout which is cut along an axial direction with a width smaller than an outer diameter of a corresponding one of the pair of protruding portions and opens toward the upper surface of the container.

10. The container containing the liquid discharge head according to claim 7, wherein in a case where outer diameters of the pair of protruding portions are equal, inner diameters of the pair of cylindrical portions are different from each other, and in a case where the inner diameters of the pair of cylindrical portions are equal, the outer diameters of the pair of protruding portions are different from each other.

11. The container containing the liquid discharge head according to claim 5, wherein a large-diameter portion of which an outer diameter is larger than an outer diameter of other portion is formed on a tip side of the protruding portion, and
wherein a small-diameter portion of which an inner diameter is smaller than an inner diameter of other portion and smaller than the outer diameter of the large-diameter portion of the protruding portion is formed on a tip side of the cylindrical portion.

12. The container containing the liquid discharge head according to claim 2, wherein the first engaging portion comprises a hole portion provided in an outer surface adjacent to the discharge port surface of the liquid discharge head,
wherein the second engaging portion comprises a protruding portion protruding from an inner surface of the container opposite to the outer surface of the liquid discharge head, and
wherein the liquid discharge head is held in the container by the protruding portion fitted into the hole portion.

13. The container containing the liquid discharge head according to claim 12, wherein the hole portion comprises a plurality of hole portions, and the protruding portion comprises a plurality of protruding portions.

14. The container containing the liquid discharge head according to claim 13, wherein the plurality of hole portions include a pair of hole portions provided in a pair of outer surfaces adjacent to the discharge port surface of the liquid discharge head, and
wherein the plurality of protruding portions include a pair of protruding portions provided on a pair of inner surfaces of the container opposite to the pair of outer surfaces of the liquid discharge head, respectively.

15. The container containing the liquid discharge head according to claim 14, wherein the pair of protruding portions are provided close to an outer surface, adjacent to the discharge port surface of the liquid discharge head, different from the pair of outer surfaces.

16. The container containing the liquid discharge head according to claim 14, wherein in a case where inner diameters of the pair of hole portions are equal, outer diameters of the pair of protruding portions are different from each other, and in a case where the outer diameters of the pair of protruding portions are equal, the inner diameters of the pair of hole portions are different from each other.

17. The container containing the liquid discharge head according to claim 12, wherein a small-diameter portion of which an inner diameter is smaller than an inner diameter of other portion is formed on an opening side of the hole portion, and
wherein a large-diameter portion of which an outer diameter is larger than an outer diameter of other portion and larger than the inner diameter of the small-diameter portion of the hole portion is formed on a tip side of the protruding portion.

18. The container containing the liquid discharge head according to claim 4, wherein the protruding portion includes a plurality of protruding portions provided with a space in between in a lateral direction on the outer surface of the liquid discharge head, and
wherein the block portion includes at least one block portion provided along the lateral direction on the inner surface of the container.

19. The container containing the liquid discharge head according to claim 1, wherein the container includes:
a container body opening at an upper surface; and
a lid which is welded to the upper surface of the container body to seal the container body.
